(19) United States
(12) Patent Application Publication
(10) Pub. No.: US 2003/0236639 A1
(43) Pub. Date: Dec. 25, 2003

(54) Sewer flow analysis method

(76) Inventor: Lynn Burton Curry, West Chester, PA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/395,392

(22) Filed: Mar. 25, 2003

Related U.S. Application Data
(60) Provisional application No. 60/367,280, filed on Mar. 26, 2002.

(51) Int. Cl. G01F 1/00; G01F 7/00

(52) U.S. Cl. 702/45

(57) ABSTRACT

A method of analyzing a sewer flow is provided. The method includes the step of calculating a set of graphical depth-versus-velocity curves, wherein each curve includes points having substantially equal volume rate of flow. The method also includes the step of measuring and graphically plotting actual flow depth data as a function of flow velocity data for the sewer flow being analyzed. The method further includes the steps of comparing the calculated curves to the plotted data, and determining sewer capacity performance and whether a sanitary sewer overflow may occur based on a result of the comparing step.

### CLAIM TO PRIORITY

The present application claims priority to U.S. Provisional Application No. 60/367,280, filed Mar. 26, 2002, the disclosure of which is incorporated herein in its entirety by reference.

### FIELD OF THE INVENTION

The present invention relates to alleviation of sanitary sewer overflows (SSOs) by comparison of “Iso-Q Lines” with flow depth-and-velocity data acquired from an open-channel flow monitor. More particularly, the invention relates to calculation, selection and display of lines of equal volume rate of flow on a graph of flow depth and flow velocity.

### DESCRIPTION OF THE RELATED ART

Owners and operators of open-channel flow systems such as sanitary sewerage systems (“utilities”) are interested in determining the flow capacity of their systems at diverse locations within the system. When the flow capacity is exceeded by the actual flow loading presented by sewerage connections and/or infiltration and inflow, experience has shown the result to be environmental impacts, public health hazards and aesthetic nuisances, in the form of raw sewage flow (backups) into building basements, and sanitary sewer overflows (SSOs) from sewer appurtenances such as manholes onto public streets, private properties, and natural watercourses.

Prior art was limited to manual scanning or data sorting of flow rates from a tabular summary, or by calculating each critical flow rate value rigorously by hand, calculator or spreadsheet. Utilities have previously had recourse only to over-simplified methods of capacity analysis yielding imprecise estimates, or theoretical computer models often poorly calibrated to actual hydraulic behavior of the systems. Recent public and regulatory attention to the serious effects of SSOs required development of a method of precisely estimating sewer capacity, based on actual documented hydraulic performance. The simple methods rely heavily on empirical relationships developed under laboratory conditions frequently not applicable to actual sewer utility performance. See, for example, Butler, D. and Davies J. W., Urban Drainage, E & F N Spon, London (2000); and Butler, D. and Pinkerton, B. R. C., Gravity Flow Pipe Design Charts, Thomas Telford, London (1987). The computer model methods are performed on a “project” basis, yielding a single analysis or set of analyses only after setting up a series of assumptions and “model runs”—they are poorly suited to administrative decision-making.

### SUMMARY OF THE INVENTION

The invention enables utilities to make a direct comparison between the validated in-situ performance of the sewer, based on actual flow monitoring data acquired by a computerized flow monitor, and a curve or set of curves, representing volumetric flow capacities, expressed as flow rates or percents of full capacity. Knowing the proportion of actual capacity currently being consumed by actual flow, the utility may make appropriate administrative and capital decisions to alleviate SSOs, by permitting or excluding further sewer connections, or by discovery and rehabilitation of infiltration and inflow sources.

Accordingly, in one aspect, the invention provides a method of analyzing a sewer flow. The method includes the step of calculating a set of graphical depth-versus-velocity curves, wherein each curve includes points having substantially equal volume rate of flow. The method also includes the step of measuring and graphically plotting actual flow depth data as a function of flow velocity data for the sewer flow being analyzed. The method further includes the steps of comparing the calculated curves to the plotted data, and determining sewer capacity performance and whether a sanitary sewer overflow may occur based on a result of the comparing step.

### BRIEF DESCRIPTION OF THE DRAWINGS

FIG. 1 shows a flow chart that illustrates a method of alleviating sanitary sewer overflows using Iso-Q lines, according to an embodiment of the present invention.

FIGS. 2a-e show scattergraph plots of collected data points overlaid with Iso-Q lines of the present invention.

FIG. 3 shows a comparison of pipe performance based on actual data with a pipe's theoretical design flow.

FIG. 4 shows the correlation of collected data with two different theoretical pipe design curves calculated using different slopes.

### DETAILED DESCRIPTION OF THE INVENTION

This invention is an analytical technique and data visualization format, which uses depth-velocity flow data and principles of hydraulic engineering and geometry. The technique involves use of lines of equal volume rate of flow, known as “Iso-Q Lines”, as a device to compare volumetric flow capacity of a conduit (generally a sewer interceptor) to a body of actual flow data presented as a graphical plot of flow depth versus flow velocity, for each individual flow data observation. By a direct visual comparison, or a discrete mathematical analysis, of the most-proximate validated actual depth-velocity data point(s) and the Iso-Q line of greatest magnitude on the chart, the engineer/analyst may correctly infer the maximum actual flow capacity of the pipe.

As defined above, “Iso-Q Lines” are lines of equal volume rate of flow. Iso-Q lines may be calculated for any pipe shape, and may be plotted on a graph of depth versus velocity for an interceptor sewer of known physical dimensions. On such a graph, shape of the Iso-Q lines is determined by the shape of the conduit. For circular pipes, at depth values less that full-pipe, they are generally curved diagonal lines; at depth values greater than full-pipe, the Iso-Q line is a straight line representing the direct proportional relationship between velocity and discharge rate. Because the same form of graph is appropriate to plot a variety of index curves—theoretical or empirical flow relationships (e.g. Manning's Equation)—these index curves may be plotted along with the Iso-Q lines. Doing so permits an analysis of the theoretical (or “design”) capacity of the pipe, and a comparison between the theoretical capacity against the actual capacity determined by documented pipe performance. Such comparisons are useful for utility owners, who must rely on such capacity determinations for a variety of operations and planning purposes.

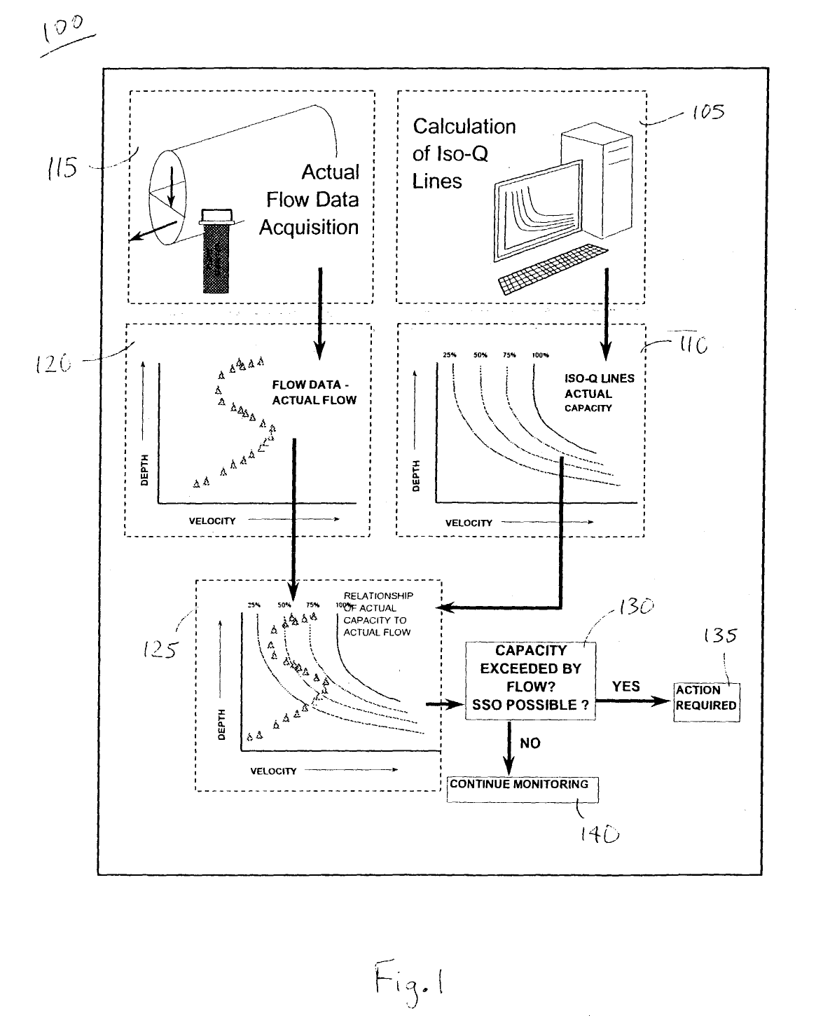

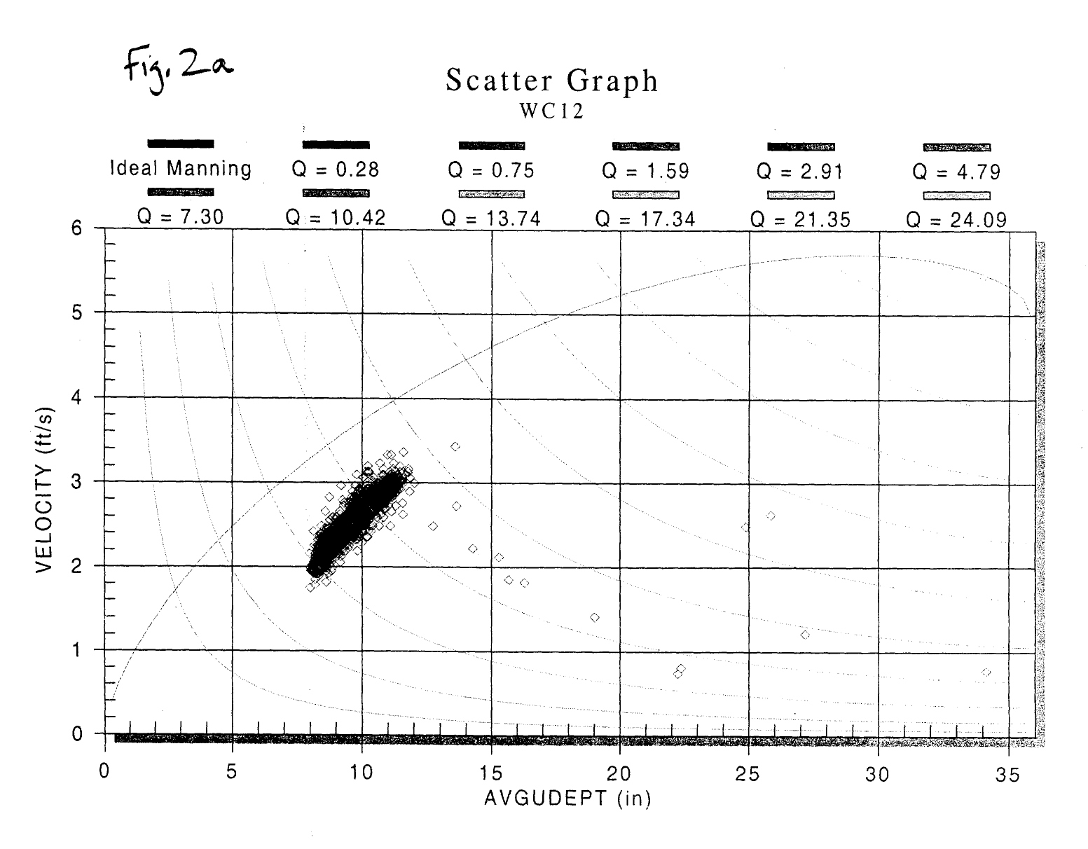

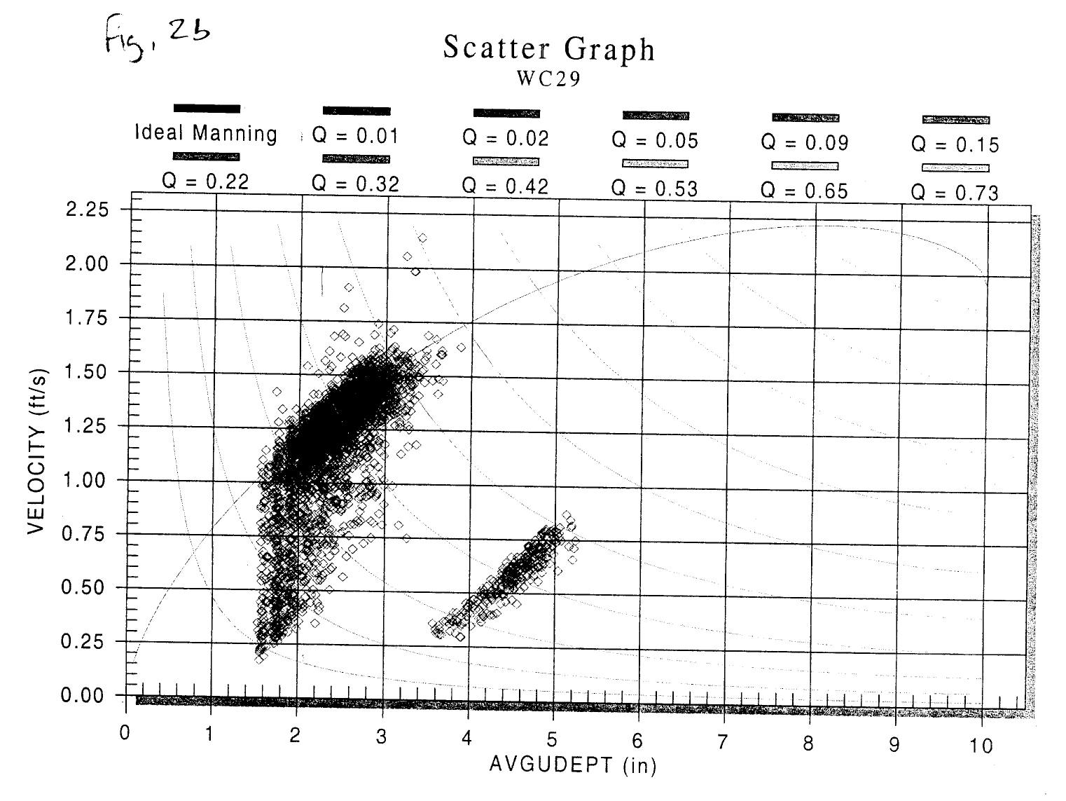

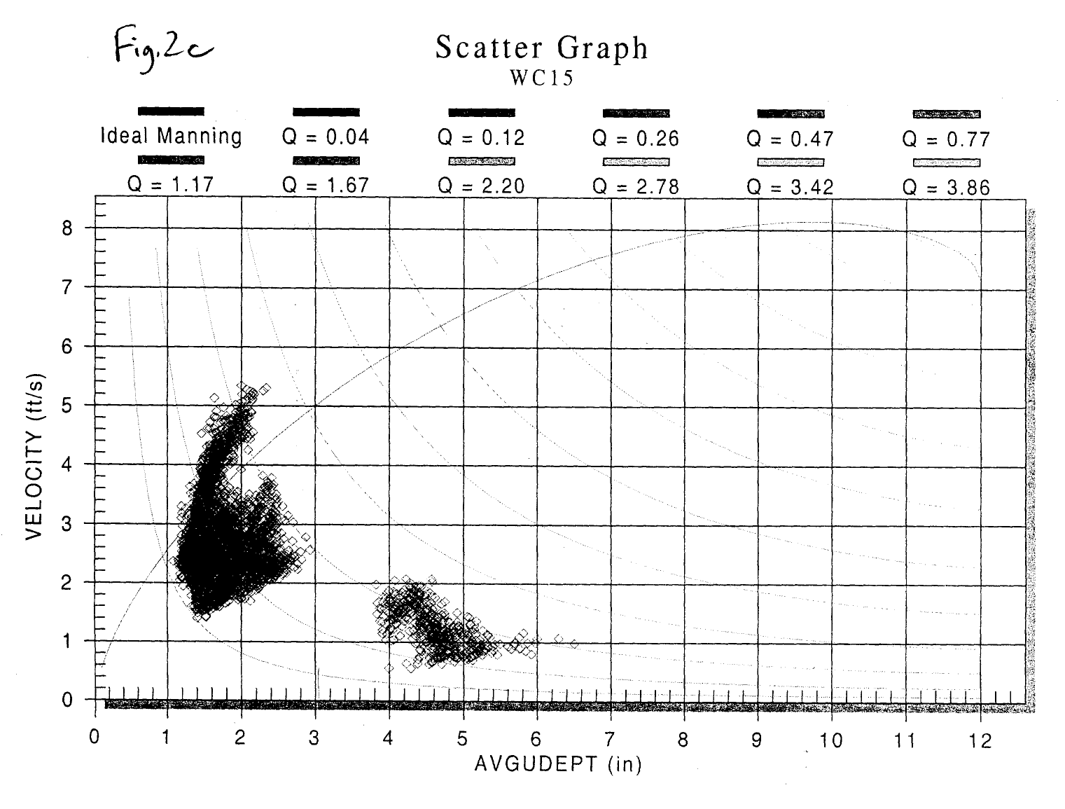

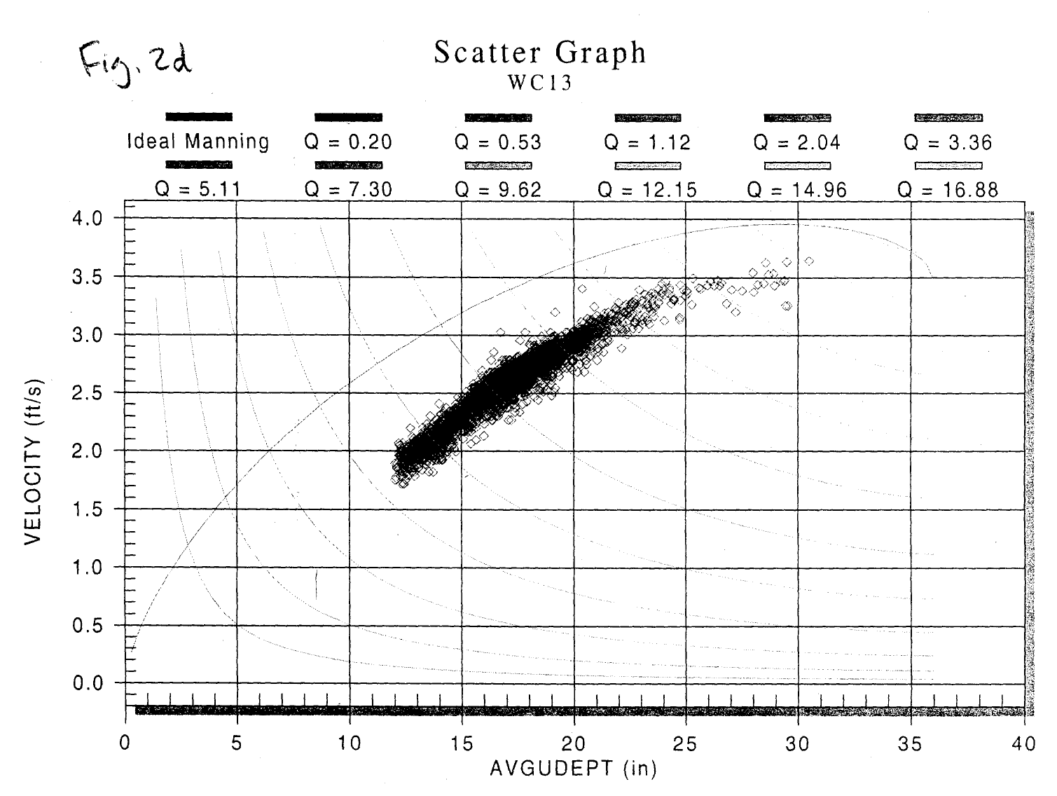

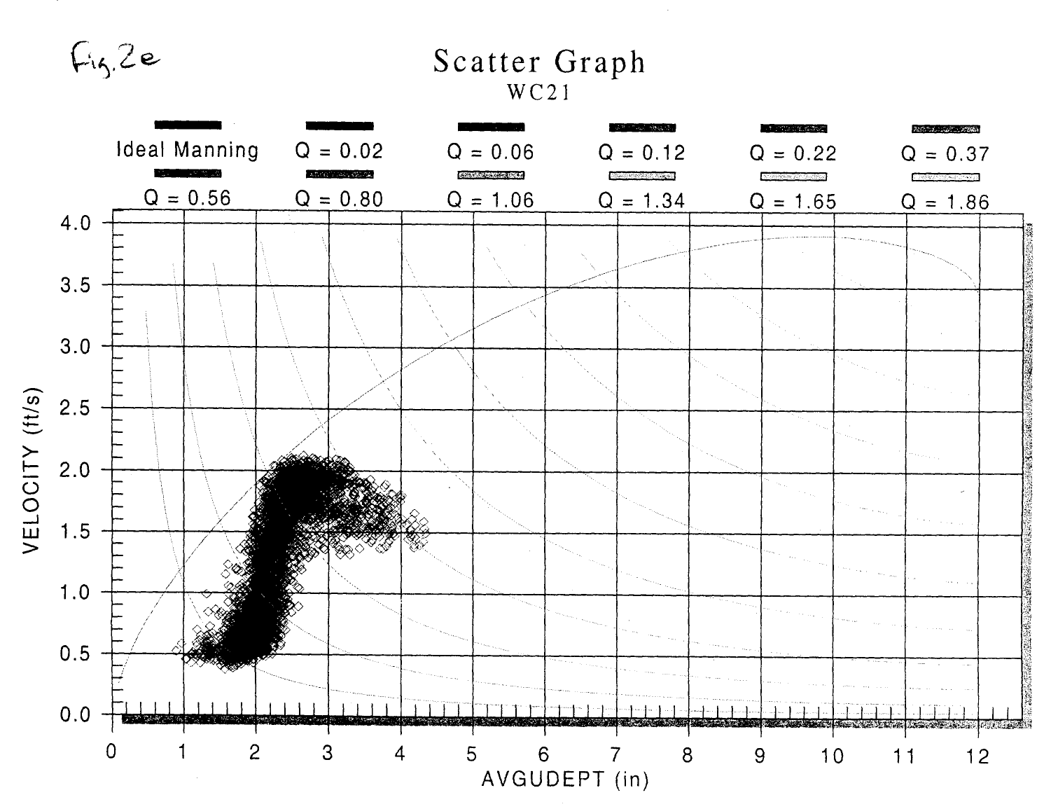

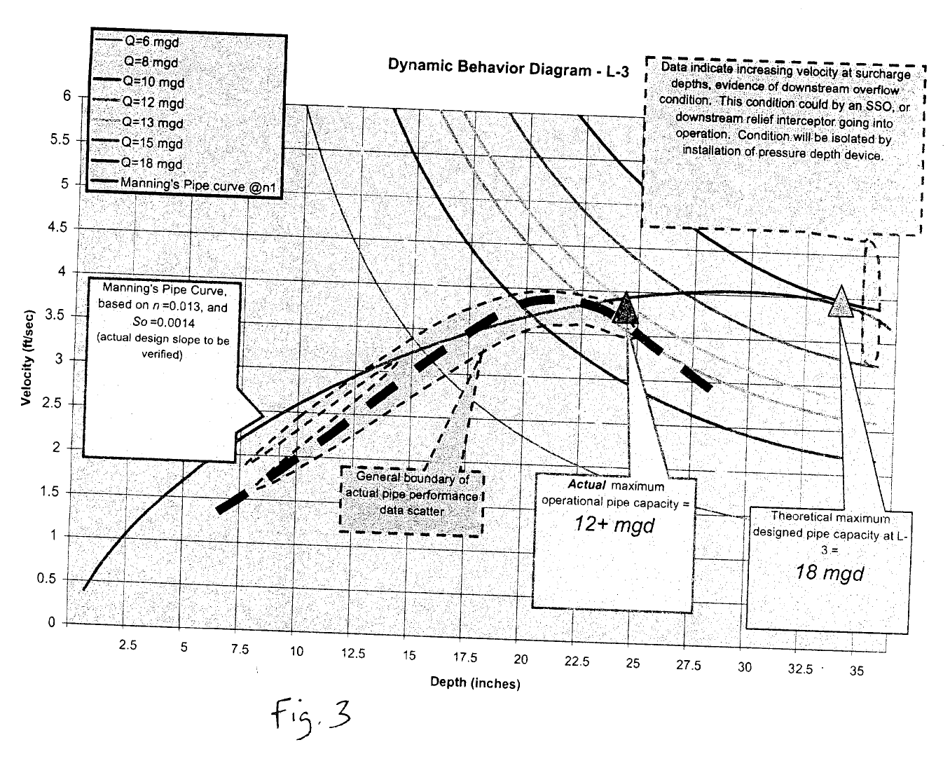

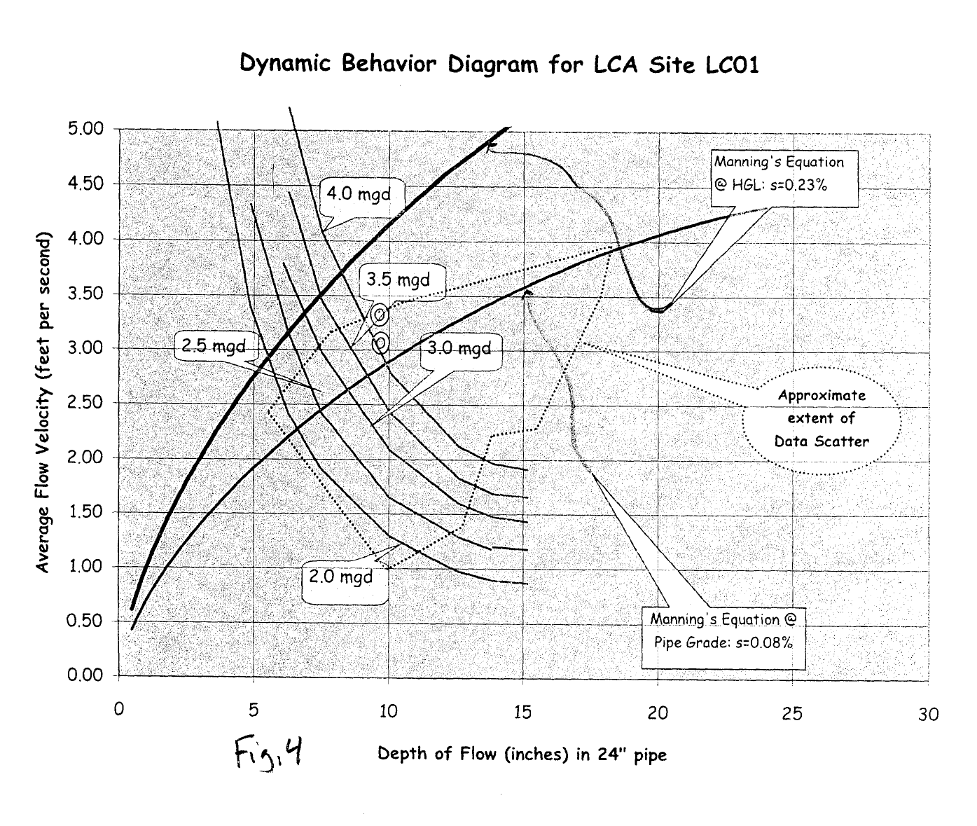

Referring to FIG. 1, a flow chart 100 illustrates a method of analyzing sewer flow data using Iso-Q lines.

At step 105, a hydraulic analyst prepares a plot of flow depth versus velocity, using scales suitable to the conditions recorded by the flow monitor. The plot may be prepared by hand, or using a computer spreadsheet. The analyst then calculates a set of solutions for the Continuity Equation (Q=AV, where A represents an average cross-sectional area of the flow, which is proportional to depth; V represents an average flow velocity; and Q represents a volume rate of flow) for the same range of depths and velocities, and a series of Q values. The Q values are chosen by the analyst based on the maximum, minimum and average flow conditions recorded by the flow monitor, and flow conditions of interest for planning and capacity management purposes. At step 110, the analyst plots a series of points or a curve from the calculated Continuity solutions, on the graph. These curves of fixed Q values are known as “Iso-Q” curves.

At step 115, flow depth and flow velocity data are then acquired by a computerized flow monitor, and then at step 120, the depth/velocity data are plotted on a graph and transferred to a computer for analysis.

At step 125, the depth/velocity data are then plotted on the graph with the Iso-Q line or lines.

At step 130, the analyst compares the flow depth/velocity points with the Iso-Q lines, and determines the maximum flow capacity of the sewer by the flow data point closest to the Iso-Q line of greatest value.

If the analyst determines that the maximum flow capacity of the sewer may be exceeded by the actual flow, and that therefore a sanitary sewer overflow event is possible, then at step 135, the analyst takes action to alleviate the sanitary sewer overflow.

If it is determined at step 130 that the maximum flow capacity of the sewer will not be exceeded by the actual flow, and therefore no sanitary sewer overflow event is imminent, then at step 140, monitoring of the actual flow data continues and no immediate action is required.

The analyst may also make determinations pertaining to sewer capacity performance by comparison of the Iso-Q lines with the flow depth/velocity data.

The analyst may plot an index curve, representing the capacity design basis for the sewer, to enable further comparisons of sewerage system capacity.

What is claimed is:

1. A method of analyzing a sewer flow, the method comprising the steps of:
calculating a set of graphical depth-versus-velocity curves, each curve including points having substantially equal volume rate of flow;
measuring and graphically plotting actual flow depth data as a function of flow velocity data for the sewer flow being analyzed;
comparing the calculated curves to the plotted data; and
determining sewer capacity performance and whether a sanitary sewer overflow may occur based on a result of the comparing step.
